(19) United States
(12) Patent Application Publication
(10) Pub. No.: US 2006/0288080 A1
(43) Pub. Date: Dec. 21, 2006

(54) Balanced computer architecture

(75) Inventors: Steven A. Orszag, Princeton, NJ (US); Sudhir Srinivasan, Chelmsford, MS (US)

Correspondence Address: JAGTIANI + GUTTAG, 10363-A DEMOCRACY LANE, FAIRFAX, VA, 22030, US

(73) Assignee: IBRIX, Inc., Billerica, MA (US)

(21) Appl. No.: 11/434,928

(22) Filed: May 17, 2006

Related U.S. Application Data
(63) Continuation-in-part of application No. 10/832,808, filed on Apr. 27, 2004.
Application No. 10/832,808 is a continuation of application No. 09/950,555, filed on Sep. 11, 2001, now Pat. No. 6,782,389.
(60) Provisional application No. 60/682,151, filed on May 18, 2005.
(60) Provisional application No. 60/683,760, filed on May 23, 2005.
(60) Provisional application No. 60/232,102, filed on Sep. 12, 2000.

(51) Int. Cl. G06F 15/16

(52) U.S. Cl. 709/217

(57) ABSTRACT

Methods and systems are described comprising a plurality of nodes each comprising at least one processor and at least one storage device providing storage for the system along with an interconnect configured to establish connections between pairs of nodes. The nodes may be configured (e.g. programmed) to determine from a file identifier that identifies a particular file that a node desires to access, which of the plurality of nodes stores the desired file. The interconnect may then establish a connection between the node and the node storing the file to permit the node desiring access to access the file (e.g., read or write the file). Further, the system comprising the plurality of nodes (e.g., a cluster computing architecture) may be balanced or nearly balanced.

### RELATED APPLICATIONS

This application is a continuation-in-part of Ser. No. 10/832,808 filed Apr. 27, 2004, which is a continuation of U.S. patent Ser. No. 09/950,555 (now U.S. Pat. No. 6,782,389) filed Sep. 11, 2001, and claims the benefit of U.S. Provisional Application No. 60/232,102 filed Sep. 12, 2000, all of which are incorporated by reference herein. This application further claims the benefit of U.S. Provisional Application No. 60/682,151 filed May 18, 2005 and U.S. Provisional Application No. 60/683,760 filed May 23, 2005, both of which are incorporated herein by reference.

### BACKGROUND

1. Field of the Invention

The present invention relates generally to computer systems, and more specifically to balanced computer architectures of cluster computer systems.

2. Related Art

Cluster computer architectures are often used to improve processing speed and/or reliability over that of a single computer. As is known to those of skill in the art, a cluster is a group of (relatively tightly coupled) computers that work together so that in many respects they can be viewed as though they are a single computer.

Cluster architectures often use parallel processing to increase processing speed. As is known to those of skill in the art, parallel processing refers to the simultaneous and coordinated execution of the same task (split up and specially adapted) on multiple processors in order to increase processing speed of the task.

Typical cluster architectures use network storage, such as a storage area network (SAN) or network attached storage (NAS) connected to the cluster nodes via a network. The throughput for this network storage is typically today on the order of 100-500 MB/s per storage controller with approximately 3-10 TB of storage per storage controller. Requiring that all file transfers pass through the storage network, however, often results in this local area network or the storage controllers being a choke point for the system.

For example, if a cluster consists of 100 processors each operating at a speed of 3 Gflops (billion floating point operations per second), the maximum speed for the cluster is 300 GFlops. If a solution to a particular algorithm has 3 million data points each requiring approximately 1000 floating point operations, then it will take approximately 30 milliseconds to complete these 3 billion operations, assuming the cluster operates at 33% of its peak speed. However, if solving this problem also requires approximately 9 million file transfers (3 times the number of data points) of 10 Bytes (or 80 bits) each and the network interconnecting the cluster nodes and the network storage is connected via gigabit Ethernet with a sustained transfer rate of 1 Gigabit per second, then these transfers will take approximately 0.7 seconds. Thus, in such an example, it will take approximately twenty times as long for the data transfers as it does for the processors to solve the problem. This accordingly results in an unbalanced system and a significant waste of processor resources. As will be discussed in more detail below, the estimated number of operations and required file transfers are reasonable estimations for solving a computer algorithm with 3 million data points

Accordingly, it has been found that typical cluster architectures do not come close to meeting the requirements for sustained transport rates necessary for a balanced system. Indeed, most current cluster architectures are designed to provide transfer rates an order of magnitude or more times slower than that necessary for a balanced network. This leads to the cluster being severely out of balance and a significant waste of resources. As such there is a need for improved methods and systems for computer architectures.

### SUMMARY

According to a first broad aspect of the present invention, there is provided system comprising a plurality of nodes each comprising at least one processor and at least one storage device providing storage for the system, and an interconnect configured to establish connections between at least a first node and a second node of the plurality of nodes. The processor of the first node of the plurality of nodes is configured to determine from a file identifier that identifies a particular file that a second node of the plurality of nodes stores the file in a storage device of the second node, direct the interconnect to establish a connection between the first node and the second node, forward a request to the second node indicating that the first node desires access to the file corresponding to the file identifier; and access the file stored by the second node.

According to a second broad aspect of the present invention, there is provided a method for use in a system comprising a plurality of nodes each comprising at least one processor and at least one storage device providing storage for the system and an interconnect configured to establish connections between at least a first node and a second node of the plurality of nodes. This method may comprise determining from a file identifier that identifies a particular file that the second node of the plurality of nodes stores the file in a storage device of the second node, directing the interconnect to establish a connection between the first node and the second node, and forwarding a request to the second node indicating that the first node desires access to the file corresponding to the file identifier; and accessing the file stored by the second node.

According to a third broad aspect of the present invention, there is provided an apparatus for use in a system comprising a plurality of nodes each comprising at least one storage device providing storage for the system and an interconnect configured to establish connections between at least a first node and a second node of the plurality of nodes. The apparatus may comprise means for determining from a file identifier that identifies a particular file that the second node of the plurality of nodes stores the file in a storage device of the second node, means for directing the interconnect to establish a connection between the first node and the second node, means for forwarding a request to the second node indicating that the first node desires access to the file corresponding to the file identifier, and means for accessing the file stored by the second node.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the claimed invention.

The accompanying drawings, which are incorporated in and constitute a part of this specification, illustrate one embodiment of the invention and together with the description, serve to explain the principles of the invention.

### BRIEF DESCRIPTION OF THE DRAWINGS

FIG. 1 illustrates a simplified block diagram of a cluster computing environment 100, in accordance with an aspect of the invention;

FIG. 2 illustrates a more detailed diagram of a cluster, in accordance with an aspect of the invention;

FIG. 3 provides a simplified logical diagram of two cluster nodes of a cluster, in accordance with an aspect of the invention;

FIG. 4 illustrates an exemplary flow chart of a method for retrieving a file, in accordance with an aspect of the invention; and

FIG. 5 illustrates a simplified diagram of an exemplary cluster architecture that includes both cluster nodes with and without direct attached storage, in accordance with an aspect of the invention.

Reference will now be made in detail to exemplary embodiments of the present invention, an example of which is illustrated in the accompanying drawings. Wherever possible, the same reference numbers will be used throughout the drawings to refer to the same or like parts.

### DETAILED DESCRIPTION

It is advantageous to define several terms before describing the invention. It should be appreciated that the following definitions are used throughout this application.

Definitions

Where the definition of terms departs from the commonly used meaning of the term, applicant intends to utilize the definitions provided below, unless specifically indicated.

For the purposes of the present invention, the term “interconnect” refers to any device or devices capable of connecting two or more devices. For example, exemplary interconnects include devices capable of establishing point to point connections between a pair of nodes, such as, for a non-blocking switch that permits multiple simultaneous point to point connections between nodes.

For the purposes of the present invention, the term “cluster node” refers to a node in a cluster architecture capable of providing computing services. Exemplary cluster nodes include any systems capable of providing cluster computing services, such as, for example, computers, servers, etc.

For the purposes of the present invention, the term “management node” refers to a node capable of providing management and/or diagnostic services. Exemplary management nodes include any system capable of providing cluster computing services, such as, for example, computers, servers, etc.

For the purposes of the present invention, the term “file identifier” refers to any identifier that may be used to identify and locate a file. Further, a file identifier may also identify the segment on which the file resides or a server controlling the metadata for the file. Exemplary file identifiers include Inode numbers.

For the purposes of the present invention, the term “storage device” refers any device capable of storing information. Exemplary storage devices include magnetic, solid state, or optical storage devices. Further, exemplary storage devices may be, for example, internal and/or external storage medium (e.g., hard drives). Additionally, exemplary storage devices may comprise two or more interconnected storage devices

For the purposes of the present invention, the term “processing speed” refers to the speed at which a processor, such as a computer processor, performs operations. Exemplary processing speeds are measured in terms of FLoating point OPerations per Second (FLOPs).

For the purposes of the present invention, the term “problem” refers to a task to be performed. Exemplary problems include algorithms to be performed by one or more computers in a cluster.

For the purposes of the present invention, the term “segment” refers to a logical group of file system entities (e.g., files, folders/directories, or even pieces of files).

For the purposes of the present invention the term “the order of” refers to the mathematical concept that F is of order G, if F/G is bounded from below and above as G increases, by a particular constants 1/K and K respectively. For example, exemplary embodiments described herein use K=5 or 10.

As used herein the term “balanced” refers to a system in which the data transfer rate for the system is greater than or equal to the minimum data transfer rate that will ensure that for the average computer algorithm solution the data transfer time is less than or equal to the processor time required.

As used herein the term “nearly balanced” refers to the data transfer rate of a system being within a factor of K=10 of the throughput required for the system to be balanced. Here K is defined as in the definition of “the order of” given above.

As used herein the term “unbalanced” refers to a system that is neither balanced nor nearly balanced.

Description

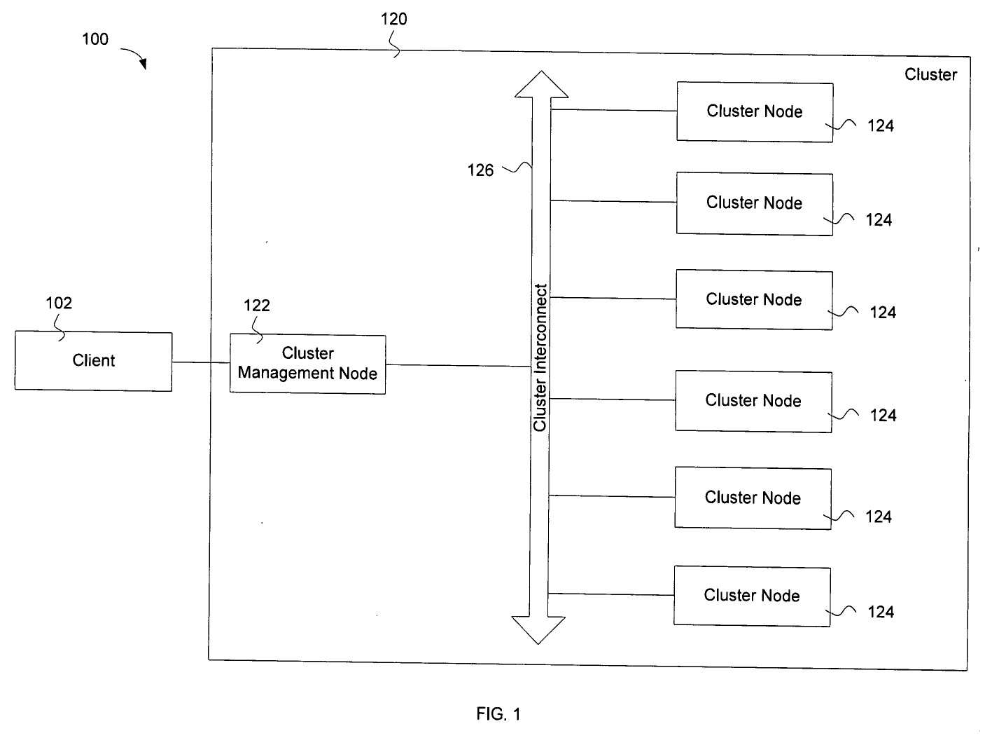

FIG. 1 illustrates a simplified block diagram of a cluster computing environment 100, in accordance with an aspect of the invention. As illustrated, a client 102 is coupled (i.e., can communicate with) to a cluster management node 122 of cluster 120. From the perspective of client 102, cluster 120 may appear to be a virtual single device residing on a cluster management node 122. Client 102 may be any type of device desiring access to cluster 120 such as, for example, a computer, personal data assistant, cell phone, etc. Further, although for simplicity FIG. 1 only illustrates a single client, in other examples multiple clients may be present. Additionally, although for simplicity FIG. 1 only illustrates a single cluster management node, in other examples multiple cluster management nodes may be present. Additionally, client 102 may be coupled to cluster management node 122 via one or more interconnects (e.g., networks) (not shown), such as, for example, the Internet, a LAN, etc. Cluster management node 122 may be, for example, any type of system capable of permitting clients 102 to access cluster 120, such as, for example, a computer, server, etc. Further, cluster management node 122 may provide other functionality such as, for example, functionality for managing and diagnosing the cluster, including the file system(s) (e.g., storage resource management), hardware, network(s), and other software of the cluster.

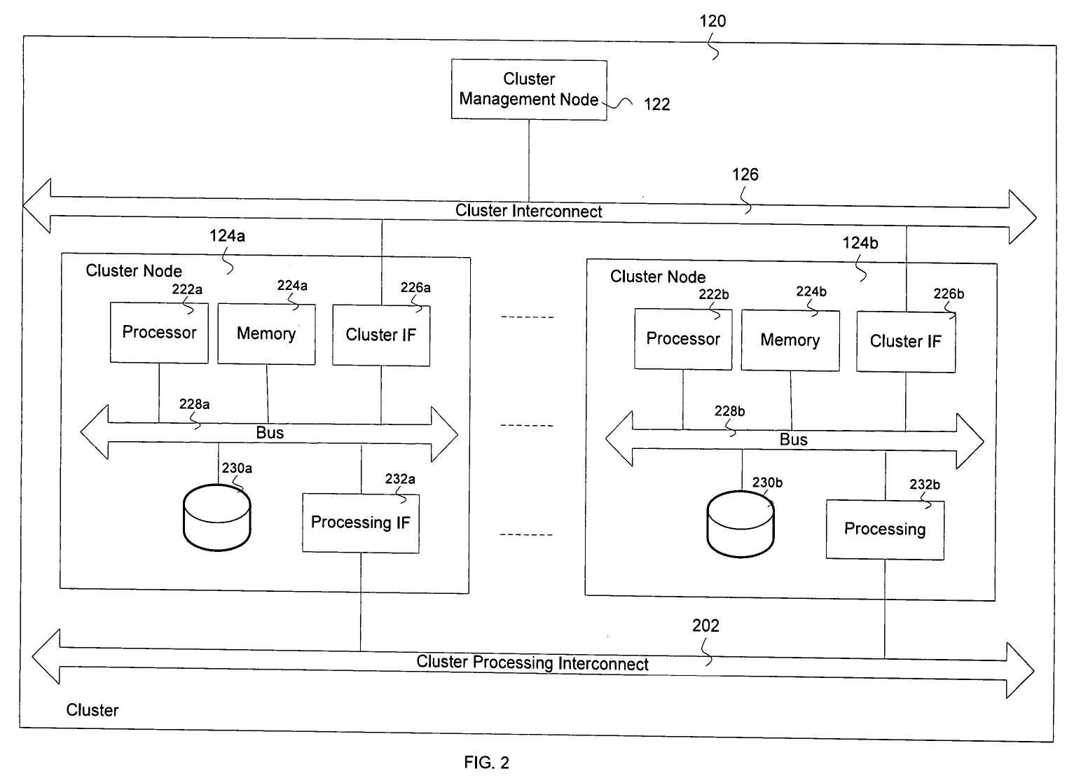

Cluster 120 further comprises a plurality of cluster nodes 124 interconnected via cluster interconnect 126. Cluster nodes 124 may be any type of system capable of providing cluster computing services, such as, for example, computers, servers, etc. Cluster nodes 124 will be described in more detail below with reference to FIG. 2. Cluster interconnect 126 preferably permits point to point connections between cluster nodes 124. For example, cluster interconnect 126 may be a non-blocking switch permitting multiple point to point connections between the cluster nodes 124. Further, cluster interconnect 126 may be a high speed interconnect providing transfer rates on the order of, for example, 1-10° Gbit/s, or higher. Cluster interconnect may use a standard interconnect protocol such as Infiniband (e.g., point-to-point rates of 10 Gb/s, 20 Gb/s, or higher) or Ethernet (e.g., point-to-point rates of 1 Gb/s or higher). It should be noted that these are but exemplary interconnects and protocols and other types of interconnects and protocols may be used without departing from the invention, such as, for example, Myrinet interconnects and protocols, and Quadrics interconnects and protocols.

FIG. 2 illustrates a more detailed diagram of cluster 120, in accordance with an aspect of the invention. As illustrated, a cluster interconnect 126 connects cluster management node 122 and cluster nodes 124. Further, cluster 120 may also include a cluster processing interconnect 202 that cluster nodes 124 may use for coordination during parallel processing and for exchanging information. Cluster processing interconnect 202 may be any type of interconnect, such as, for example, a 10 or 20 Gb/s Infiniband interconnect or a 1 Gb/s Ethernet. Further, in other embodiments, cluster processing interconnect 202 may not be used, or additional other interconnects may be used to interconnect the cluster nodes 124

Cluster nodes 124 may include one or more processors 222, a memory 224, a Cluster processing interconnect interface 232, one or more busses 228, a storage subsystem 230 and a cluster interconnect interface 226. Processor 222 may be any type of processor, including multi-core processors, such as those commonly used in computer systems and commercially available from Intel and AMD. Further, in implementations cluster node 124 may include multiple processors. Memory 224 may be any type of memory device such as, for example, random access memory (RAM). Further, in an embodiment memory 224 may be directly connected to cluster processing interconnect 202 to enable access to memory 224 without going through bus 228.

Cluster processing interconnect interface 232 may be an interface implementing the protocol of cluster processing interconnect 202 that enable cluster node 124 to communicate via cluster processing interconnect 202. Bus 228 may be any type of bus capable of interconnecting the various components of cluster node 124. Further, in implementations cluster node 124 may include multiple internal busses.

Storage subsystem 230 may, for example, comprise a combination of one or more internal and/or external storage devices. For example, storage subsystem 230 may comprise one or more independently accessible internal and/or external hierarchical storage medium (e.g., magnetic, solid state, or optical drives). That is, in examples, employing a plurality of storage devices, each of these storage devices may, in certain embodiments, be accessed (e.g., for reading or writing data) simultaneously and independently by cluster node 124. Further, each of these independent storage devices may themselves comprises a plurality of internal and/or external storage mediums (e.g., hard drives) accessible by one or more common storage controllers and may or may not be virtualized as RAID devices.

Cluster node 124 may access storage subsystem 220 using an interface technology, such as SCSI, Infiniband, FibreChannel, IDE, etc. Cluster interconnect interface 226 may be an interface implementing the protocol of cluster interconnect 126 so as to enable cluster node 124 to communicate via cluster interconnect 126.

In an embodiment, cluster 120 is preferably balanced. The following provides an overview of balancing a cluster, such as those discussed above with reference to FIGS. 1-2.

As noted above, cluster 120 may use parallel processing in solving computer algorithms. The number of computer operations required to solve typical computer algorithms is usually of the order N log₂ N or better as opposed to, for example, N², where N is the number of points used to represent the dataset or variable under study. Further, modern scientific and technological application codes generally have an effective upper bound for the required number of operations per data that is no larger than about U=max(k,15 log₂ N), where k is typically between 200-1000. A further description of this effective upper bound is provided in George M. Karniadakis and Steven Orszag, “Nodes, Modes, and Flow Codes,” Physics Today pg. 34-42 (March 1993), which is hereby incorporated by reference. Examples of N log N scaling include the fast Fourier transform (FFT), the fast multipole transform, etc. For simplicity, in the below description, we shall estimate U=1000, which may be an overestimate in some applications.

If a cluster consists of M cluster nodes each operating at a speed of P floating operations per second (Flops), the speed of the cluster is at best MP flops. Typically, when applications are well designed for a cluster, the speed of the cluster may be designed to normally operate at approximately 33% of this peak, although still higher percentages may be preferable. Thus, the computer time required to solve a computer algorithm will generally be about 3 NU/MP seconds.

Additionally, in cluster computing, computer algorithms are generally not contained solely within the memory (e.g., RAM) of a single cluster node, but instead typically require input and output (“I/O”) operations. There are at least three kinds of such I/O operations: (1) those internal to the cluster node (e.g., transfers to/from storage subsystem 230 of the cluster node 124); (2) those external to the cluster node (e.g., transfers between different cluster nodes 124 of cluster 120); (3) those to and from network storage. A reasonable lower limit for the number of required I/O operations is 3N word transfers per algorithm solution. A further description of this lower limit is provided in the above incorporated reference George M. Karniadakis and Steven Orszag, “Nodes, Modes, and Flow Codes,” Physics Today pg. 34-42 (March 1993). If the rate of data transfer of any type of I/O operation is assumed to occur at a data rate of R Bytes/sec, and assuming 64 bit arithmetic that uses 8 Bytes/word, the time for performing these 3N transfers is at least 24N/R seconds.

As noted above, in order to obtain system balance, it is preferable that the transfer time be of order the problem solution time, i.e. 3 NU/MP≈24N/R, or R>≈8 MP/U≈MP/125, where U is assumed to be 1000, as noted above. In other words, to achieve a balanced cluster, the sustained I/O data rate is preferably approximately (or greater than) R≈MP/125.

Additionally, good programming practice typically involves storing “check points” approximately every ten minutes (600 seconds) or so. As is known to those of skill in the art, a check point is a dump of memory (e.g., the cluster computer's RAM) to disk storage that may be used to enable a system restart in the event of a computer or cluster failure. In typical computer practice, it is common to design a cluster so that the memory (e.g., RAM) measured in Bytes is roughly 50-100% of the throughput MP/3 measured in Flops. Thus, to achieve a check point within 600 seconds typically requires that MP/3R<600 or R>MP/2000. However, as noted above, to achieve system balance typically requires R≈MP/125. Thus, in most applications achieving system balance as noted above, provides ample time for storing “check points.”

In an embodiment of the present invention, cluster 120 implements a file system in which one or more cluster nodes 124 use direct attached storage (“DAS”) (e.g., storage devices accessible only by that cluster node and typically embedded within the node or directly connected to it via a point-to-point cable) to achieve system balance. The following provides an exemplary description of an exemplary file system capable of being used in a cluster architecture to achieve system balance.

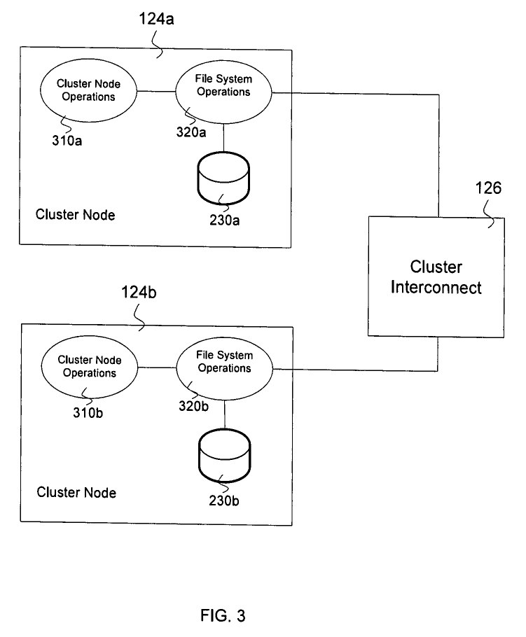

FIG. 3 provides a simplified logical diagram of two cluster nodes 124a and 124b of cluster 120, in accordance with an aspect of the invention. Cluster nodes 124a and 124b, as illustrated, each include both a logical block for performing cluster node operations 310 and a logical block for performing file system operations 320. Both cluster node operations 310 and file systems operations 320 may be executed by processor 222 of cluster node 124 using software stored in memory 224, storage subsystem 230, a separate storage subsystem, or any combination thereof. Cluster node operations 310 preferably include operations for communicating with cluster management node 122, computing solutions to algorithms, and interoperating with other cluster nodes 124 for parallel processing.

File system operations 320 preferably include operations for retrieving stored information, such as, for example, information stored in storage subsystem 230 of the cluster node 124 or elsewhere, such as, for example, in a storage subsystem of a different cluster node. For example, if cluster node operations 310a of cluster node 124a requires information not within the cluster's memory 224, cluster node operations 310a may make a call to file system operations 320a to retrieve the information. File system operations 320a then checks to see if storage system 230a of cluster node 124a includes the information. If so, file system operations 320a retrieves the information from storage system 230a.

If, however, storage system 230a does not include the desired information, file system operations 320a preferably retrieves the information from wherever it may be stored (e.g., from a different cluster node). For example, if storage subsystem 230b of cluster node 124b stores the desired information, file system operations 320a preferably directs cluster interconnect 126 to establish a point to point connection between file system operations 320a of cluster node 124a and file system operations 320b of cluster node 124b. File system operations 320a then preferably obtains the information from storage subsystem 230b via file system operations 320b of cluster node 124b.

As noted above, cluster interconnect 126 is preferably a non-blocking switch permitting multiple high speed point to point connections between cluster nodes 124a and 124b. Further, because cluster interconnect 126 establishes point to point connections between cluster nodes 124a and 124b, file system operations 320a and 320b need not use significant overhead during data transfers between the cluster nodes 124. As is known to those of skill in the art, overhead may add latency to the file transfer which effectively slows down the system and reduces the systems effective transfer. Thus, in an embodiment, a data transfer protocol using minimal overhead is used, such as, for example, Infiniband, etc. As noted above, in order to ensure approximate balance of cluster 120, it is preferably that the average transfer rate, R, for the cluster be greater than or equal to MP/125, as discussed above.

In an embodiment, file system operations 320 stores information using a file distribution methods and systems such as described in the parent application, U.S. Pat. No. 6,782,389, entitled “Distributing Files Across Multiple Permissibly Heterogeneous, Storage Devices,” which is incorporated herein in its entirety. For example, as described therein, rather than using a disk (or some other discrete storage unit or medium), as a fundamental unit of a file system, the file system's fundamental units may be “segments.”

A “segment” refers to a logical group of objects (e.g., files, folders, or even pieces of files). A segment need not be a file system itself and, in particular, need not have a ‘root’ or be a hierarchically organized group of objects. For example, referring back to FIG. 2, if a cluster node 124 includes a storage subsystem 230 with a capacity of, for example, 120 GB, the storage subsystem 230 may store up to, for example, 30 different 4 GB segments. It should be noted that these sizes are exemplary only and different sizes of segments and storage subsystems may be used. Further, in other embodiments, segment sizes may vary from storage subsystem to storage subsystem.

In an embodiment, each file (also referred to herein as an “Inode”) is identified by a unique file identifier (“FID”). The FID may identify both the segment in which the Inode resides as well as the location of the Inode within that segment, e.g. by an “Inode number.”

In another embodiment, each segment may store a fixed maximum number of Inodes. For example, if each segment is 4 GB and assuming an average file size of 8 KB, the number of Inodes per segment may be 500,000. Thus, in an embodiment, a first segment (e.g., segment number 0) may store Inode numbers 0 through 499,999; a second segment (e.g., segment number 1) may store Inode numbers 500,000 through 999,999, and so on. Thus, in an embodiment, to determine which segment stores a particular Inode, the Inode number may simply be divided by the constant 500,000 (i.e., the number of Inodes allocated to each segment) and take the resulting whole number. For example, the Inode for Inode number of 1,953,234, in this example, would be stored in segment 3 (1,953,234/500,000=3.9). In another embodiment, the fixed maximum number of Inodes in any segment is a power of 2 and therefore the Inode number within a segment is derived simply by using some number of the least significant bits of the overall Inode number (the remaining most significant bits denoting the segment number).

In an embodiment, each cluster node 124 maintains a copy of a map (also referred to as a routing table) indicating which cluster node 124 stores which segments. Thus, in such an embodiment, when computing a solution to a particular algorithm, file system operations 320 for a cluster node 124 may simply use the Inode number for a desired file to determine which cluster node 124 stores the desired file. Then, file system operations 320 for the cluster node 124 may obtain the desired file as discussed above. For example, if the file is stored on the storage subsystem 230 for the cluster node, it can simply retrieve it. If however, the file is stored by a different cluster node, file systems operations 320 may direct cluster interconnect 126 to establish a point to point connection between the two cluster nodes to retrieve the file from the other cluster node. In another example, rather than using an explicit routing table for mapping which cluster node stores which segment, the segment number may be encoded into a server number. For example, if the segment number in decimal form is ABCD, the server may simply be identified as digits BD. Note, for example, if the segment number were instead simply AB then modulo division may be used to identify the server.

Further, in an embodiment, each storage subsystem 230 may store a special file, referred to as a superblock that contains a map of all segments residing on the storage subsystem 230. This map may, for example, list the physical blocks on the storage subsystem where each segment resides. Thus, when a particular file system operations 320 receives a request for a particular Inode number stored in a segment on a storage subsystem 230 for the cluster node, file system operations 320 may retrieve the superblock from the storage subsystem to look up the specific physical blocks of storage subsystem 230 storing the Inode. This translation of an Inode address to the actual physical address of the Inode, accordingly may be done by the file system operations 320 of the cluster node 124 where the file is located. As such, the cluster node operations 310 requesting the Inode need not know anything about where the actual physical file resides.

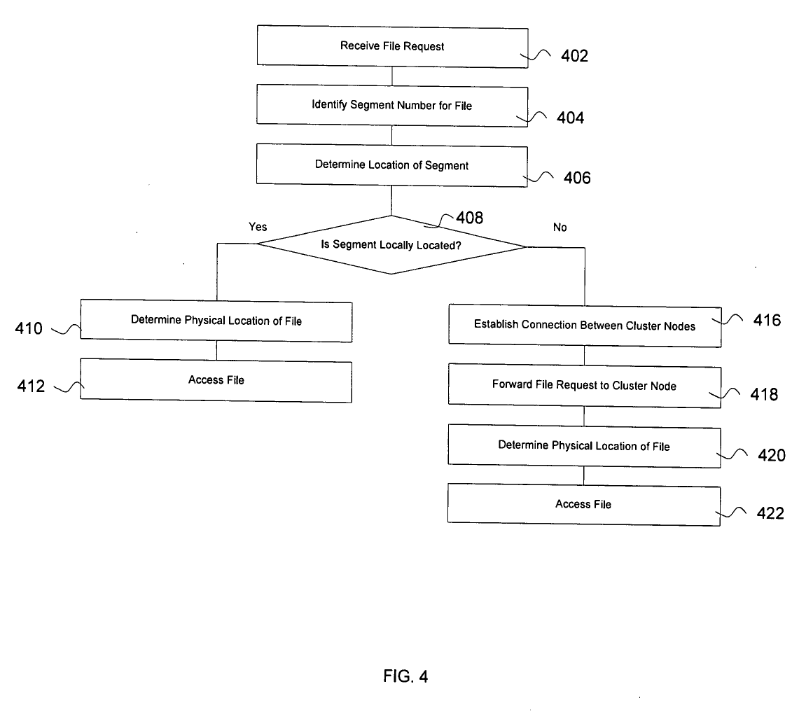

FIG. 4 illustrates an exemplary flow chart of a method for accessing a file, in accordance with an aspect of the invention. This flow chart will be described with reference to the above described FIG. 3. Initially file system operations 320a receives a call to access a file (also referred to as an Inode) from cluster operations 310a at block 402. This call preferably includes a FID (e.g., Inode number) for the requested file. Next, file system operations 320a identifies the segment in which the file is located at block 404 using the FID, either by extracting the segment number included in the FID or by applying an algorithm such as modulo division or bitmasking to the FID as described earlier. The file system operations 320a then identifies which cluster node stores the segment at block 406. Note that blocks 404 and 406 may be combined into a single operation in other embodiments. Further, if the storage subsystem 230 of the cluster node 124 comprises, for example, multiple storage devices (e.g., storage disks), this map further identifies the particular storage device on which the segment is located.

Next, the file system operations 320a determines whether the storage subsystem 230a for the cluster node 124a includes the identified segment, or whether another cluster node (e.g., cluster node 124b) includes the segment at block 408. If the cluster node 124a includes the segment, file system operations 320a at block 410 accesses the superblock from the storage subsystem 230a to determine the physical location of the file on storage subsystem 230a. As noted above, storage subsystem 230a may include a plurality of independently accessible storage devices, each storing their own superblock. Thus, the accessed superblock is for the storage device on which the identified segment is located. The file system operations 320a may then access the requested file from the storage subsystem 230a at block 412.

If cluster node 124a does not include the identified segment, file system operations 320a directs cluster interconnect to set up a point to point connection between cluster node 124a and the cluster node storing the requested file at block 416. File system operations 320a may use, for example, MPICH (message passing interface) protocols in communicating across cluster interconnect 126 to set up the point to point connection. For explanatory purposes, the other cluster node storing the file will be referred to as cluster node 124b.

File system operations 320a of cluster node 124a then sends a request to file system operations 320b of cluster node 124b for the file at block 418. File system operations 320b at block 420 accesses the superblock from the storage subsystem 230b to determine the physical location of the file on storage subsystem 230b. As noted above, storage subsystem 230b may include a plurality of independently accessible storage devices, each storing their own superblock. Thus, the accessed superblock is for the storage device on which the identified segment is located. The file system operations 320b may then access the requested file from the storage subsystem 230b at block 422. For example, in an exemplary read operation, this access may be accomplished by, for example, file system operations 320b retrieving the file and providing the file to file system operations 320a. Or, for example, in an exemplary write operation, this file access may be accomplished by file system operation 320a providing the file to file system operations 320b, which then stores the file in storage subsystem 230b. As a further embodiment, a file system may be used such as described in U.S. patent application Ser. No. 10/425,550 entitled, “Storage Allocation in a Distributed Segmented File System” filed Apr. 29, 2003, which is hereby incorporated by reference, to determine on which segment to store the file. Referring again to FIG. 4, when a new file is being created, the storage subsystem 230a may select a segment to place the file in at block 404. The file may be allocated non-hierarchically in that the segment chosen to host the file may be any segment of the entire file system, independent of the segment that holds the parent directory of the file—the directory to which the file is attached in the namespace.

As noted above, it is preferable that the cluster be balanced. The following discusses an exemplary balanced cluster, such as illustrated in FIGS. 2-3 and using a file system employing segments, such as discussed above. In this embodiment, cluster 120 may consist of 56 cluster nodes (i.e., M=56) each with two 2.2 GHz AMD Opteron dual core processors 222 (i.e., P=4.4 GFlops/core*2cores/chip*2 chip=17.6 GFlops/node). Thus, MP/125=(56 nodes)*(17.6 GFlops/node)/125=7.9 GBytes/s. Thus, in this example, to achieve system balance the sustained throughput for the cluster should be about 8 GBytes/s.

Further, in this exemplary embodiment, the storage system 230 for each cluster node comprises two disk storage drives (e.g., 2×146 GByte per node) each disk having an access rate of 100 MB/s. Further, in this example the cluster interconnect 126 may be a 1 GB/s Infiniband interconnect. Thus, in this example, the maximum transfer rate for the cluster will be approximately 5.6 GB/s (200 MB/s*56/2 possible non-blocking point-to-point interconnects between pairs of cluster nodes). As such, because this maximum transfer rate, 5.6 GB/s is slightly smaller than 8 GB/s, this exemplary cluster is still considered to be a nearly balanced cluster. As used herein the term “nearly balanced” refers to the transfer rate being within a factor of 10 (K=10) of the throughput required to be balanced. If the system is neither balanced nor nearly balanced, the system is consider unbalanced.

It should be noted that this is but one exemplary embodiment of a balanced network in accordance with an aspect of the invention and other embodiments may be used. For example, in an embodiment cluster interconnect 126 may be a different type of interconnect, such as, for example, a Gigabit Ethernet. However, it should be noted that Gigabit Ethernet typically requires more overhead than Infiniband, and as a result may introduce greater latency into file transfers that may reduce the effective data rate of the Ethernet to below 1 Gbps. For example, a 1 Gbps Ethernet translates to 125 MBps. If, for example, the translation to the Ethernet protocol requires 5 milliseconds, then a transfer of 1.25 MB would take 0.015 seconds (0.005 s latency+0.010 s for transfer after conversion). This results in an effective transfer rate of 1.25 MB/0.015 s=83 MBps. Thus, in this example, in which the average file size is 1.25 MB and the latency is 0.005 s, the Ethernet would be the limiting factor in determining the average sustained throughput for the network.

It should be noted that these file sizes and latencies are exemplary only and provided merely to describe how latencies involved in file transfers may reduce transfer rates. For example, in this example, the transfer rate from any one cluster node would be limited by this 83 MBps effective transfer rate of the Interconnect. Thus, assuming 56 nodes, the maximum throughput would be 28×83 MBps=2.3 GBps. If, however, the average file size if 12.5 MB, then the effective throughput would be 119 MBps (12.5 MB/(0.10 s transfer+0.005 s latency)) and the maximum transfer rate for the cluster (assuming the transfer rate of storage subsystems 230 was sufficiently fast) would be 3.3 GBps. As such, in an embodiment, latency is also taken into account when designing the architecture to ensure that the architecture is balanced.

Further, in embodiments, compiler extensions, such as, for example, in C, C++, or Fortran, may be used that implement allocation policies that are designed to improve the efficient solution of algorithms and retrieval of data in the architecture. As used herein the term “compiler” refers to a computer program that translate programs expressed in a particular language (e.g., C++, Fortran, etc.) into it machine language equivalent. In an embodiment, a compiler may be used for generating code for exploiting the parallel processing capabilities of the cluster. For example, the compiler may be such that it may split up an algorithm into smaller parts that each may be processed by a different cluster node. Parallel processing, cluster computing, and the use of compilers for same are well known to those of skill in the art and are not described further herein.

In an embodiment, compiler extensions may be developed that take advantage of the high throughput of the presently described architecture. For example, such a compiler extension might be used to direct a particular cluster node to store data it creates (or data it is more likely to use in the future) on its own storage subsystem, rather than having the data be stored on a different cluster nodes storage subsystem, or, for example, on a network attached storage (NAS). Exemplary algorithms to accomplish such allocation policies are described in the above incorporated by reference U.S. patent application Ser. No. 10/425,550.

For example, if a cluster node stores information it is more likely to need in its storage subsystem, the cluster node can simply retrieve it from its own storage subsystem without using the cluster interconnect. This may effectively increase the transfer rate for the cluster. For example, if the cluster node stores a file it needs, it need not retrieve the file via the cluster interconnect. As such, the retrieval of the file may occur at a faster transfer rate than file transfers that must traverse the cluster interconnect. This accordingly may increase the overall transfer rate for the network and help lead to more balanced networks. As such, in an embodiment, the software for the cluster (e.g., compiler extensions are used) is designed to take advantage of this so that cluster nodes store files they are most likely to access.

Further, compiler extensions may be used to implement a particular migration policy. As used herein the term “migration policy” refers to how data is moved between cluster nodes to balance the load throughout the cluster.

In another embodiment, a cluster architecture may be implemented that includes both cluster nodes with direct attached storage and cluster nodes without direct attached storage (but with network storage). This network storage may, for example, be a NAS or SAN storage solution. In such an example, the system may be designed such that the sustained average throughput for the system is sufficient to achieve system balance.

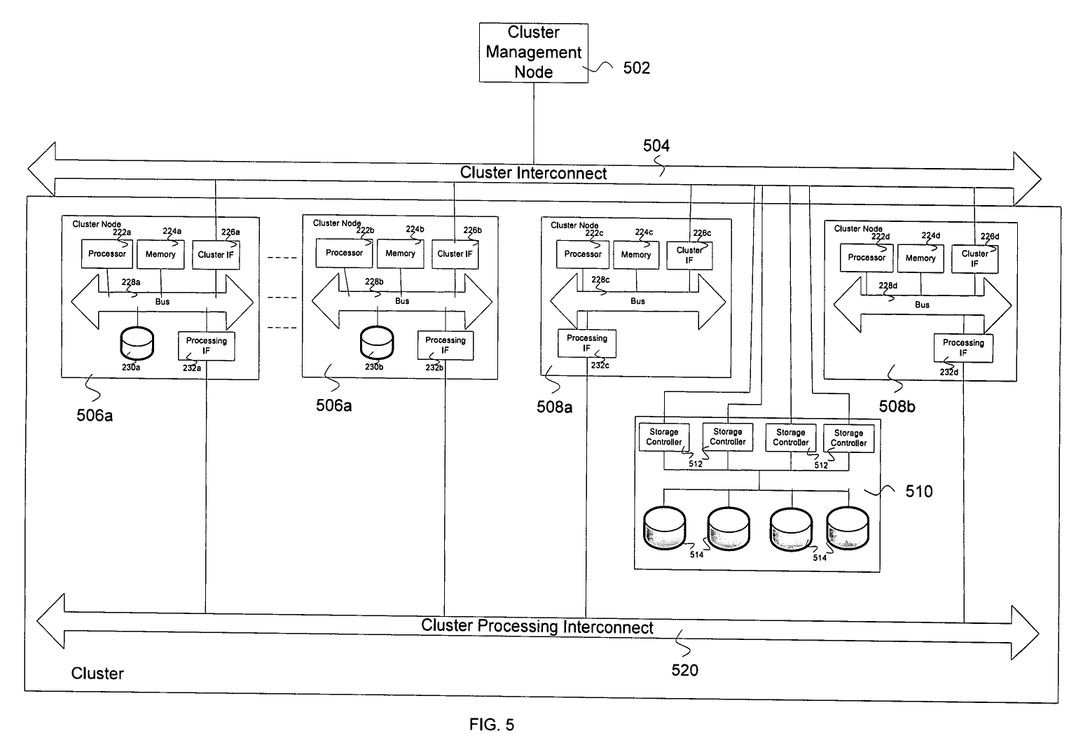

FIG. 5 illustrates a simplified diagram of an exemplary cluster architecture that includes both cluster nodes with and without direct attached storage, in accordance with an aspect of the invention. Cluster 500, in this example, includes a cluster management node 502 and a cluster interconnect 504 that may interconnect the various cluster nodes 506a, 506b, 508a and 508b, cluster management node 502, and a storage system 510. As with the above-discussed embodiments, cluster management node 502 may be any type of device capable of managing cluster 500 and functioning as an access point for clients that wish to obtain cluster services. Further, as with the above-discussed embodiments, cluster interconnect 504 is preferably a high speed interconnect, such as a gigabit Ethernet, 10 gigabit Ethernet, or Infiniband type interconnect.

As illustrated, cluster 500 includes two types of cluster nodes: those with direct attached storage 506a and 506b and those without direct attached storage 508a and 508b. This direct attached storage may be a storage subsystem such as storage subsystem 230 discussed above with reference to FIG. 2. Storage system 510, as illustrated, which may be, for example, a NAS or SAN, may include a plurality of storage devices (e.g., magnetic) 514 and a plurality of storage controller 512 for accessing data stored by storage devices 514. It should be noted, that this is a simplified diagram and, for example, storage system 510 may include other items, such as for example, one or more interconnects, an administration computer, etc.

Cluster 500 may also include a cluster processing interconnect 520 like the cluster processing interconnect 202 for exchanging data between cluster nodes during parallel processing. As with the embodiments discussed above, cluster processing interconnect 520 may be a high speed interconnect such as, for example an Infiniband or Gigabit Ethernet interconnect.

Further, in this example, the system may implement a file system using segments such as discussed above. Thus, each cluster node 506 and 508 may store a map that indicates where each segment resides. That is, this map indicates which segments each storage subsystem 230 of each cluster node 506a or 506b and the storage system 510 store. Thus, as with the above discussed embodiment, a cluster node 506 or 508 may simply divide the Inode number for the desired Inode by a particular constant to determine to which segment the Inode belongs. The file system operations of the cluster node 506 or 508 may then look up in the map which cluster node stores this particular segment (e.g., cluster node 506a or 506b or storage system 510). The file system operation for the cluster node may then direct cluster interconnect 504 to establish a point to point connection between the cluster node 506 or 508 and the identified device (if the desired Inode is not stored by storage subsystem of the cluster node making the request). The identified device may then supply the identified Inode via this point to point connection to the cluster node making the request.

As with the above embodiment, the exemplary cluster of FIG. 4 is preferably balanced. That is, the interconnect, number of cluster nodes with DAS, and the number of storage controllers of the storage system 510 are such that the system has sufficient throughput so that that the computation of a solution to a particular algorithm is not slowed down due to file transfers. For example, if cluster 500 includes 100 nodes each with a two 2.2 GHz dual-core AMD Opteron processors, then M=100 and P=4.4 GFlops/core*2cores/chip*2 chips/node=17.6 GFlops/node. Therefore, for system balance the sustained transport rate, R, should be greater than or equal to MP/125=100*17.6 GFlops/125=14.1 GBps.

Cluster interconnect 504, in this example, may be a 1 GBps Infiniband interconnect permitting point to point connections between the cluster nodes 506 and 508 and storage controllers 512. Further, in this example, storage system 510 may include 4 storage controllers each capable of providing a transfer rate of 500 MB/s. Further, in this example, 75 of the cluster nodes comprise a DAS storage subsystem 230 including two storage disks each with a transfer rate of 100 MBps, while 25 cluster nodes 508 do not have DAS storage. Thus, in this example, the maximum throughput for the cluster is 200 MBps/node*75 nodes+500 MBps/storage controller*4 storage controllers which provides a maximum transfer rate of 17 GBps. As such, in this example, the system would also be balanced.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart there from.

What is claimed is:

1. A system comprising:
a plurality of nodes each comprising at least one processor and at least one storage device providing storage for the system; and
an interconnect configured to establish connections between at least a first node and a second node of the plurality of nodes;
wherein a processor of the first node of the plurality of nodes is configured to determine from a file identifier that identifies a particular file that a second node of the plurality of nodes stores the file in a storage device of the second node; direct the interconnect to establish a connection between the first node and the second node; forward a request to the second node indicating that the first node desires access to the file corresponding to the file identifier; and access the file stored by the second node.

2. The system of claim 1, wherein the average processor time for the processor nodes to solve a problem is the order of the average time of transfers between pairs of computers in solving the problem.

3. The system of claim 2, wherein the plurality of nodes comprise M nodes and wherein the processors for each of the M nodes are configured to provide a processing speed, P, for the node; and wherein the interconnect is configured to establish one or more point to point connections between one or more pairs of nodes at a cumulative data rate R; and wherein the data rate, R, of the interconnect is the order of MP/125.

4. The system of claim 1, wherein the storage for the system comprises a plurality of segments each identified by a unique identifier and wherein each segment stores files identified by a range of file identifiers; and wherein the processor of the first node in determining that the second node stores the file, is further configured to: identify the segment storing the file using the file identifier for the file; and identify the node storing the identified segment.

5. The system of claim 4, wherein the processor is further configured to identify the segment by determining the unique identifier for the segment by dividing the file identifier by a predetermined number, and identify the node storing the identified segment by looking up the determined unique identifier in a table.

6. The system of claim 4, wherein the file identifier comprises an Inode number and information regarding the unique identifier for the segment; and
wherein the processor is further configured to obtain the unique identifier for the segment from the file from the file identifier.

7. The system of claim 4, wherein the file identifier comprises an Inode number and information identifying a computer node responsible for the file associated with the Inode number; and
wherein the processor is further configured to identify the computer node responsible for the file.

8. The system of claim 1, wherein the interconnect comprises a non-blocking switch.

9. The system of claim 8, wherein the interconnect is selected from the set of an Infiniband interconnect, a Gigabit Ethernet interconnect, 10 Gigabit Ethernet interconnect, Myrinet interconnect, and a Quadrics interconnect.

10. The system of claim 1, wherein the system further comprises:
a storage system selected from the set of a network attached storage (NAS) and a storage area network (SAN); and
a second plurality of nodes each of which does not comprise a storage device providing storage for the system, and; wherein each of the second plurality of nodes comprises a processor configured to access a file stored by the storage system and to access a file stored by the second node.

11. A method for use in a system comprising a plurality of nodes each comprising at least one processor and at least one storage device providing storage for the system and an interconnect configured to establish connections between at least a first node and a second node of the plurality of nodes, the method comprising:
determining from a file identifier that identifies a particular file that the second node of the plurality of nodes stores the file in a storage device of the second node;
directing the interconnect to establish a connection between the first node and the second node;
forwarding a request to the second node indicating that the first node desires access to the file corresponding to the file identifier; and
accessing the file stored by the second node.

12. The method of claim 11, wherein the average processor time for the processors of the nodes to solve a problem is the order of the average time of transfers between pairs of nodes in solving the problem.

13. The method of claim 12, wherein the plurality of nodes comprise M nodes and wherein the processors for each of the M nodes are configured to provide a processing speed, P, for the node; and wherein the interconnect is configured to establish one or more point to point connections between one or more pairs of nodes at a cumulative data rate R; and wherein the data rate, R, of the interconnect is the order of MP/125.

14. The method of claim 11, wherein the storage for the system comprises a plurality of segments each identified by a unique identifier and wherein each segment stores files identified by a range of file identifiers; wherein in determining that the second node stores the file, the method further comprises:
identifying the segment storing the file using the file identifier for the file; and
identifying the node storing the identified segment.

15. The method of claim 14, wherein identifying the segment further comprises:
determining the unique identifier for the segment by dividing the file identifier by a predetermined number; and
wherein identifying the node storing the identified segment further comprises:
looking up the determined unique identifier in a table.

16. The method claim 14, wherein the file identifier comprises an Inode number and information regarding the unique identifier for the segment, the method further comprising:
obtaining the unique identifier for the segment for the file from the file identifier.

17. The method of claim 14, wherein the file identifier comprises an Inode number and information identifying a computer node responsible for the file associated with the Inode number, the method further comprising:
identifying the computer node responsible for the file.

18. The method of claim 11, wherein the interconnect comprises a non-blocking switch.

19. The method of claim 18, wherein the interconnect is selected from the set of an Infiniband interconnect a Gigabit Ethernet interconnect, 10 Gigabit Ethernet interconnect, Myrinet interconnect, and a Quadrics interconnect.

20. The method of claim 11, wherein the system further comprises a storage system selected from the set of a network attached storage (NAS) and a storage area network (SAN) and a second plurality of nodes each of which does not comprise a storage device providing storage for the system, the method further comprising:
at least one of the second plurality of nodes accessing a file stored by the storage system; and
at least one of the second plurality of nodes accessing a file stored by the second node.

21. An apparatus for use in a system comprising a plurality of nodes each comprising at least one storage device providing storage for the system and an interconnect configured to establish connections between at least a first node and a second node of the plurality of nodes, the apparatus comprising:
means for determining from a file identifier that identifies a particular file that the second node of the plurality of nodes stores the file in a storage device of the second node;
means for directing the interconnect to establish a connection between the first node and the second node;
means for forwarding a request to the second node indicating that the first node desires access to the file corresponding to the file identifier; and
means for accessing the file stored by the second node.

22. The apparatus of claim 21, wherein each node comprises means for solving a problem and wherein the average processor time for the processors of the nodes to solve a problem is the order of the average time of transfers between pairs of nodes in solving the problem.

23. The apparatus of claim 22, wherein the plurality of nodes comprise M nodes and wherein the processors for each of the M nodes are configured to provide a processing speed, P, for the node; and wherein the interconnect is configured to establish one or more point to point connections between one or more pairs of nodes at a cumulative data rate R; and wherein the data rate, R, of the interconnect is the order of MP/25.

24. The apparatus of claim 21, wherein the storage for the system comprises a plurality of segments each identified by a unique identifier and wherein each segment stores files identified by a range of file identifiers; and wherein the means for determining that the second node stores the file comprises:
means for identifying the segment storing the file using the file identifier for the file; and
means for identifying the node storing the identified segment.

25. The apparatus of claim 24, wherein the means for identifying the segment further comprises:
means for determining the unique identifier for the segment by dividing the file identifier by a predetermined number; and
wherein the means for identifying the node storing the identified segment further comprises:
means for looking up the determined unique identifier in a table.

26. The apparatus of claim 24, wherein the file identifier comprises an Inode number and information regarding the unique identifier for the segment, the apparatus further comprising:
means for obtaining the unique identifier for the segment for the file from the file identifier.

27. The apparatus of claim 24, wherein the file identifier comprises an Inode number and information identifying a computer node responsible for the file associated with the Inode number, the method apparatus further comprising:
means for identifying the computer node responsible for the file.

28. The apparatus of claim 21, wherein the interconnect comprises a non-blocking switch.

29. The apparatus of claim 28, wherein the interconnect is selected from the set of an Infiniband interconnect a Gigabit Ethernet interconnect, 10 Gigabit Ethernet interconnect, Myrinet interconnect, and a Quadrics interconnect.

30. The apparatus of claim 21, wherein the system further comprises a storage system selected from the set of a network attached storage (NAS) and a storage area network (SAN) and a second plurality of nodes each of which does not comprise a storage device providing storage for the system, the apparatus further comprising:
means for accessing a file stored by the storage system.
